(19) United States
(12) Patent Application Publication
(10) Pub. No.: US 2014/0149152 A1
(43) Pub. Date: May 29, 2014

(54) System and Method for Interactive Travel Planning and Funds Management

(71) Applicant: Outski Inc., Tucson, AZ (US)

(72) Inventor: Greg Nickolson, Tucson, AZ (US)

(21) Appl. No.: 14/093,144

(22) Filed: Nov. 29, 2013

Related U.S. Application Data
(60) Provisional application No. 61/731,085, filed on Nov. 29, 2012.

(51) Int. Cl. G06Q 10/02

(52) U.S. Cl. CPC G06Q 10/02; G06Q 40/02
USPC 705/5

(57) ABSTRACT

Systems and methods for interactive travel planning and funds management according to various aspects of the present technology may comprise a planning coordination system accessible over a network that is configured to allow a user to plan and organize travel events. The system may also comprise a funds management system that provides the user with a method of saving for the planned travel event. The funds management system may also be configured to allow the user to pay for travel components relating to the planned travel event. The planning coordination system may provide the user with an estimated budget based on selected parameters relating to the planned travel event, and the funds management system may allow the user to save and allocate funds to pay for the travel event from a specifically created user savings account. The planning coordination system may also provide for collaborative planning by allowing the user to invite others to join a planned travel event.

### CROSS-REFERENCE TO RELATED APPLICATION

This application claims the benefit of U.S. Provisional Patent Application No. 61/731,085, Nov. 29, 2012, and incorporates the disclosure of the application by reference.

### BACKGROUND OF INVENTION

Social networks allow users to interact with each other in various ways to share information regarding interests and activities across political, economic, and geographic borders. This interaction may take place over a public network such as the Internet. Popular social networks allow users to exchange personal information with selected users, provide direct methods of communication such as instant messaging, blogging, and email. Social networks may utilize a website to attract users and provide a central theme or concept.

For example, some social networks may comprise a website directed towards allowing users to share common experiences or information relating to travel. Users may share personal experiences associated with a particular tourist location, attraction, museum, park, restaurant, and/or travel provider. These experiences may be grouped according to interest, topic, user name, style, or any other suitable criteria. Additional users may then access and/or respond to these experiences creating an environment leading to an exchange of information relating to a particular interest.

A common feature among the various social networks and other electronic methods of communication is that users are limited to providing comments in text format. Likewise, users who upload images to a social network or otherwise communicate images to others over email are only given the option of including text based descriptions to describe the image.

### SUMMARY OF THE INVENTION

Systems and methods for interactive travel planning and funds management according to various aspects of the present invention may comprise a planning coordination system accessible over a network that is configured to allow a user to plan and organize travel events. The system may also comprise a funds management system that provides the user with a system and method of saving for the planned travel event. The funds management system may also allow the user to pay for travel components relating to the planned travel event. The planning coordination system may provide the user with an estimated budget based on selected parameters relating to the planned travel event and the funds management system may allow the user to save and allocate funds to pay for the travel event from a specifically created user savings account. The planning coordination system may also provide for collaborative planning by allowing the user to invite others to join a planned travel event.

### BRIEF DESCRIPTION OF THE DRAWINGS

A more complete understanding of the present invention may be derived by referring to the detailed description when considered in connection with the following illustrative figures. In the following figures, like reference numbers refer to similar elements and steps throughout the figures.

FIG. 1 representatively illustrates an interactive travel planning system in accordance with an exemplary embodiment of the present invention;

FIG. 2 representatively illustrates a planning coordination system and funds management system in accordance with an exemplary embodiment of the present invention;

FIG. 3 representatively illustrates a graphical user interface in accordance with an exemplary embodiment of the present invention;

FIG. 4A representatively illustrates a first interface window of the graphical user interface in accordance with an exemplary embodiment of the present invention;

FIG. 4B representatively illustrates a second interface window of the graphical user interface in accordance with an exemplary embodiment of the present invention;

FIG. 4C representatively illustrates a third interface window of the graphical user interface in accordance with an exemplary embodiment of the present invention;

FIG. 4D representatively illustrates a fourth interface window of the graphical user interface in accordance with an exemplary embodiment of the present invention;

FIG. 5 representatively illustrates a detailed trip page of the graphical user interface in accordance with an exemplary embodiment of the present invention; and

FIG. 6 illustrates a flow chart for the travel planning system in accordance with an exemplary embodiment of the present invention.

### DETAILED DESCRIPTION OF EXEMPLARY EMBODIMENTS

The present technology may be described in terms of functional block components and various processing steps. Such functional blocks may be realized by any number of hardware or software components configured to perform the specified functions and achieve the various results. For example, the present technology may employ systems, technologies, algorithms, devices, designs, services and the like, which may carry out a variety of functions. In addition, the present technology may be practiced in conjunction with any number of hardware and software applications and environments, such as websites, social network media, and applications configured to link users, and the system described is merely one exemplary application. The present technology may also be practiced in conjunction with any number of processes such as travel reservation, banking, and social media communications, and the system described is merely one exemplary application and may employ any number of conventional techniques for Internet communications, real-time user interaction, messaging, travel reservations, and/or electronic funds transfer.

The present technology may also involve multiple programs, functions, computers and/or servers. While the exemplary embodiments may be described in conjunction with conventional computers, the various elements and processes may be implemented in hardware, software, or a combination of hardware, software, and other systems. Software and/or software elements according to various aspects of the present technology may be implemented with any software language or standard, such as, for example, MultiDimensional eXpressions language (MDX), AJAX, C, C++, Java, COBOL, assembly, PERL, eXtensible Markup Language (XML), PHP, etc., or any other programming, scripting, query, or other software language or standard, whether now known or later developed. Further, the present technology may employ any number of conventional techniques for providing systems and methods for managing and presenting information.

The particular implementations shown and described are illustrative of the technology and the best mode and are not intended to otherwise limit the scope of the claims in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

Systems and methods for interactive travel planning according to various aspects of the present invention may operate in conjunction with any suitable telecommunication network, travel reservation system or service such as a web-based travel provider or an aggregator, computing process or machine, phone, smartphone, tablet, server, navigation system, or other device with access to a telecommunication network, such as the Internet. Various representative implementations of the present technology may be applied to any electronic device or application configured to access a web page or a social network to purchase and/or reserve travel-related products and services.

Various representative algorithms may be implemented with any combination of data structures, objects, processes, routines, other programming elements, computing components, units, devices, and/or the like. Further, the present technology may employ any number of conventional techniques for data transmission, signaling, data processing, network control, and/or the like. Applications according to various aspects of the present technology may be formulated and a network may be provided that may include any system for exchanging data, such as, for example, a telecommunication network such as the Internet, an intranet, an extranet, WAN, LAN, satellite communications, and/or the like. The network may be implemented as other types of networks, such as an interactive television (ITV) network. The users may interact with the system by any input device such as a keyboard, mouse, kiosk, personal digital assistant, handheld computer, cellular phone such as a smartphone that may have access to the Internet, text messaging by cellular phone, and/or the like.

Similarly, the technology may be used in conjunction with any type of personal computing device, network computer/server, workstation, minicomputer, mainframe, or the like running any operating system such as any version of Windows, Android, Mac OS X, OS/2, BeOS, Linux, UNIX, or any other operating system, whether now known or hereafter developed. Moreover, the technology may be implemented with TCP/IP communications, IPX, AppleTalk, IP-6, NetBIOS, OSI or any number of existing or future protocols. The various computing devices described herein may be referred to as computing devices.

A computing device may comprise conventional components, such as a processor, a local memory such as RAM, long-term memory such as a hard disk, solid state drive, or flash memory, a network interface, and any number of input and/or output peripherals such as a keyboard, mouse, monitor, touch screen, and the like. The various memories of the computing device may facilitate the storage of one or more computer instructions, such as a software routine and/or software program, which may be executable by the processor to perform the methods of the technology. A computing device may be referred to as a computer, a computing component, and the like. A computing device may comprise a personal computer, server, mobile phone, smartphone, tablet computer, kiosk, and the like. Further, the databases, systems, and/or components of the present technology may comprise any combination of databases, systems, and/or components at a single location or at multiple locations. Each database, system, and/or component of the present technology may comprise any suitable security features, such as firewalls, access codes, encryption, de-encryption, compression, decompression, and/or the like.

Individual computing devices may be connected with each other by a telecommunication network. The telecommunication network may comprise a collection of terminal nodes, links, and any intermediate nodes, which are connected to enable communication at a distance between the terminal nodes. A telecommunication network may be simply referred to as a network. In some embodiments, a terminal node may comprise a computing device. The computing devices and telecommunication network may facilitate cloud computing. The network may be a public network and assumed to be insecure and open to eavesdroppers. The network may also be a private network and assumed to be secure and closed to eavesdroppers. In one exemplary implementation, the network may be embodied as the Internet. In this context, computers may or may not be connected to the Internet at all times.

Telecommunication may be accomplished through any suitable communication system, such as, for example, a telephone network, intranet, Internet, point of interaction device (point of sale device, personal digital assistant, cellular phone, kiosk, etc.), online communications, off-line communications, wireless communications, a radio dispatch network, and/or the like.

A variety of conventional communications media and protocols may be used for the communication links, such as, for example. Bluetooth, a connection to an Internet Service Provider (ISP) over the local loop as is typically used in connection with standard modem communication, wireless cellular communication, cable modem, dish networks, ISDN, Digital Subscriber Line (DSL), and/or various wireless communication methods. Polymorph code systems might also reside within a local area network (LAN) which interfaces to a network through a leased line (T1, T3, etc.). A communicative link may comprise any form or method for communication, such as a computer network, communication between software routines, and the like. A communicative link may comprise any intermediary device, system, method, and the like, between the two items so linked.

The present technology may be embodied as a method, a system, a device, and/or a computer program product. Accordingly, the present technology may take the form of an entirely software embodiment, an entirely hardware embodiment, or an embodiment combining aspects of both software and hardware. The methods of the present technology may be performed by a single computing device, or may be performed by any combination of multiple computing devices. The systems of the present technology may comprise cloud computing systems, and the methods of the present technology may be performed using cloud computing. Furthermore, the present technology may take the form of a computer program product on a non-transitory computer-readable storage medium having computer-readable program code embodied in the storage medium. Any suitable computer-readable storage medium may be utilized, including hard disks, CD-ROM, optical storage devices, magnetic storage devices, USB memory keys, and the like.

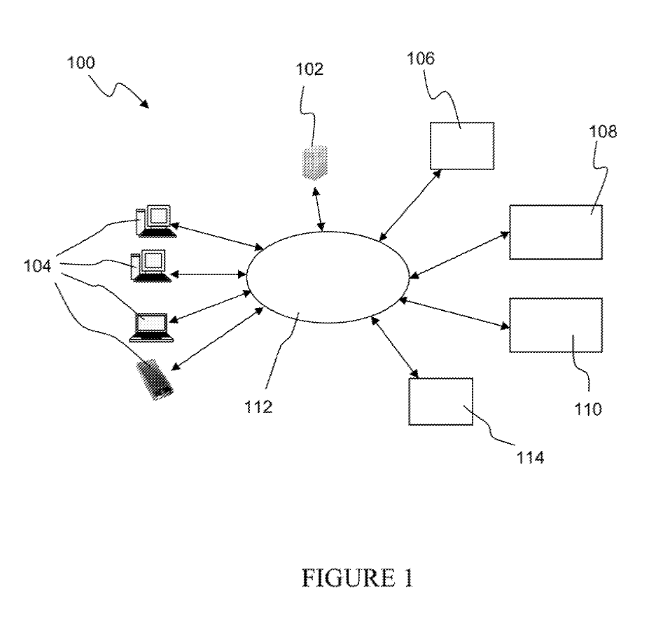

Referring now to FIG. 1, in an exemplary embodiment of the present technology, an interactive travel planning system 100 may comprise a travel planning system 102 configured to communicatively interface with one or more user computing devices 104 over a network 112, such as the Internet. The travel planning system 102 may be further configured to access or otherwise communicatively link over the network 112 to external service providers such as: a travel reservation system 106; a banking system 108; a social media network 110; an online marketplace 114; and the like.

The social media network 110 provides a conduit for multiple users to interact with each other via the network 112 to create, share, and exchange information. The social media network 110 may comprise any suitable method or system allowing multiple users to interact. The social media network 110 may comprise a public or private network utilizing web-based and mobile technologies to facilitate information exchange between users. For example, the travel planning system 102 may allow the user computing devices 104 to share information between the travel planning system 102 and the social media network 110. In one embodiment, the travel planning system 102 may be integrated into a first social media site and be suitably configured to communicate information received from the user computing devices 104 to the travel reservation system 106 and/or communicate information from the travel reservation system 106 to the user computing devices 104. In an alternative embodiment, the user computing devices 104 may be configured to send or receive information directly with the travel planning system 102.

The travel reservation system 106 provides a conduit for the user to search for and/or purchase one or more travel components. The travel reservation system 106 may comprise any suitable method or system allowing the user to research, reserve, book, and/or purchase any product or service associated with travel such as lodging, airfare, car rental, public transit passes, tickets for attractions, dining reservations, and the like. The travel reservation system 106 may comprise a publicly or privately accessed network utilizing web-based and mobile technologies allowing users to purchase travel related products and/or services. For example, in one embodiment, the travel reservation system 106 may comprise a third party website configured to allow the user to search for components such as airfare and/or lodging according to any desired criteria, such as a planned travel dates, destination, desired amenities, or cost. The travel reservation system 106 may then present the user with one or more options based upon the selected criteria that may be reviewed, purchased, and/or shared with other users. In an alternative embodiment, the travel reservation system 106 may be directly linked between a provider of one or more travel components and the travel planning system 102 such that the user may be able to search for and purchase the travel components through the travel planning system 102 without the need to visit or access a third party website or provider.

The travel reservation system 106 may comprise a system capable of providing only a single travel component, such as airfare from a single airline, or it may be adapted to provide multiple travel components such as hotels, airfare, and rental cars from multiple providers so that the user can compare prices and options prior to purchasing or reserving any desired travel components. The travel reservation system 106 may also be suitably adapted to automatically search for travel components, special deals, or packages based upon criteria such as user preferences and travel components selected as part of a saved trip. Alternatively, the travel reservation system 106 may comprise a system adapted to provide complete/pre-planned vacation packages that may be purchased or reserved. The travel reservation system 106 may also be adapted to connect to more localized reservation systems that may not be captured by some travel aggregators, such as a system for making reservations at: restaurants; bed and breakfast establishments; local hotels/motels; home rental services; transportation; tour operators; and the like.

The banking system 108 provides a financial link to coordinate the transfer of funds between one or more elements of the interactive travel planning system 100. The banking system 108 may comprise any suitable funding source or repository such as an online bank, an escrow service, an electronic funds transfer service, online/mobile payment processor, money transmitter, peer-to-peer digital currency service, and the like. In one embodiment, the banking system 108 may comprise a bank that provides the user with a user savings account created for use with the interactive travel planning system 100. The user savings account may comprise any suitable type of financial account, such as a non-interest bearing savings account, an account tied to a reloadable debit card, an account that may provide the user with a stored value card upon request, or an account tied to a mobile payment system such as a smartphone.

The online marketplace 114 may comprise any suitable online provider of goods or services that may be accessed over the network 112. The online marketplace 114 may comprise any suitable method or system for allowing the user to search and/or purchase goods or services. In one embodiment, in response to an input from the user computing devices 104 indicating that a particular item needs to be purchased, the travel planning system 102 may direct the user to an online retailer associated with the type of goods or services corresponding to the received input. For example, the online marketplace 114 may comprise an e-commerce retailer of goods, a travel insurance provider, the post office, and the like.

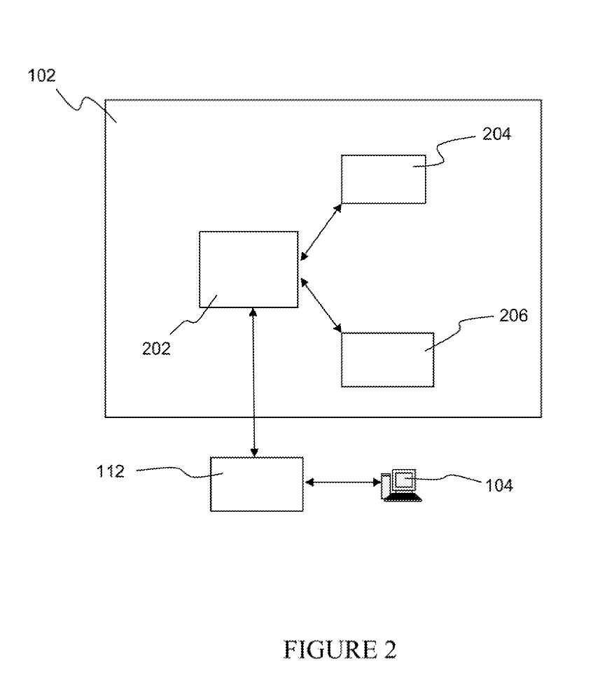

The travel planning system 102 provides the user with an interface to plan a trip for one or more travelers, create a savings plan for the trip, facilitate the transfer of funds from a user bank account to the travel savings account, allocate funds between the travel saving account and a payment method, and/or manage funds within the travel savings account and the payment method, for example in real-time. The travel planning system 102 may comprise any suitable system for facilitating a travel planning process, coordinating the required financial savings associated with the planned trip, and managing available funds. Referring now to FIG. 2, in one embodiment, the travel planning system 102 may comprise a server 202 communicatively linked to a planning coordination system 204 and a funds management system 206. The server 202 may be configured to communicate a graphical user interface to the user computing devices 104 to facilitate the exchange of data between the user computing devices 104 and the travel planning system 102.

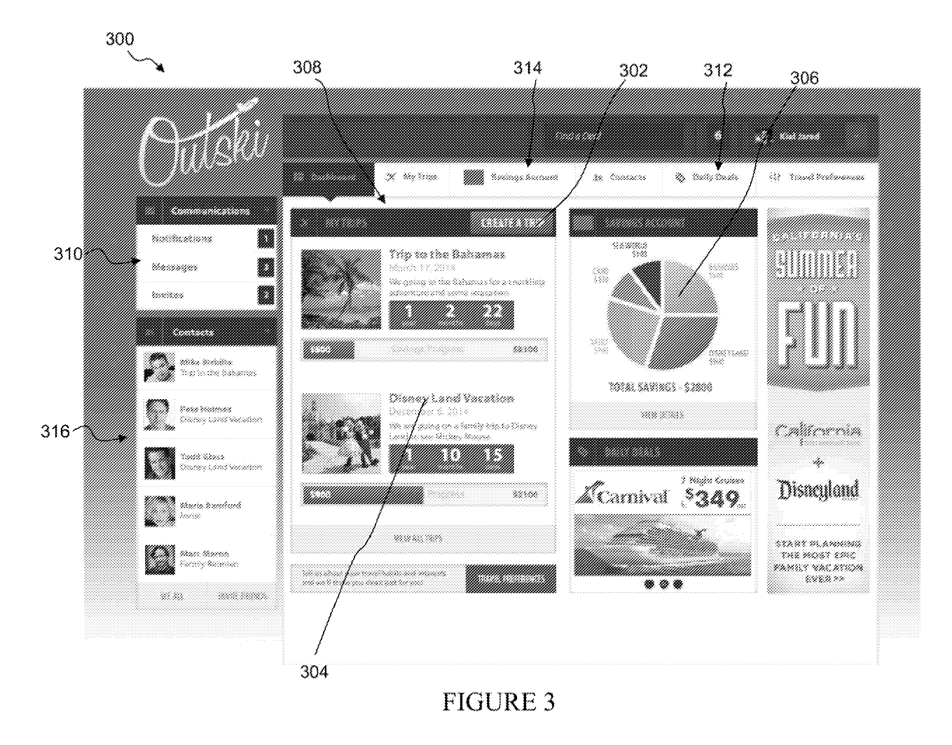

For example, referring now to FIG. 3, upon accessing the travel planning system 102, a user may be presented with a Dashboard page 300. The Dashboard page 300 may provide the user with an overview of planned trips 308, completed trips, and a savings summary 306. The Dashboard page 300 may also provide the user with an option to create a new trip 302, view or send messages 310, view travel deals 312, access the funds management system 314, 206, or access other users' public profile pages 316. In one embodiment, in response to the user clicking on a button to create a new trip 302, the planning coordination system 204 may initiate a process to guide the user through one or more planning steps.

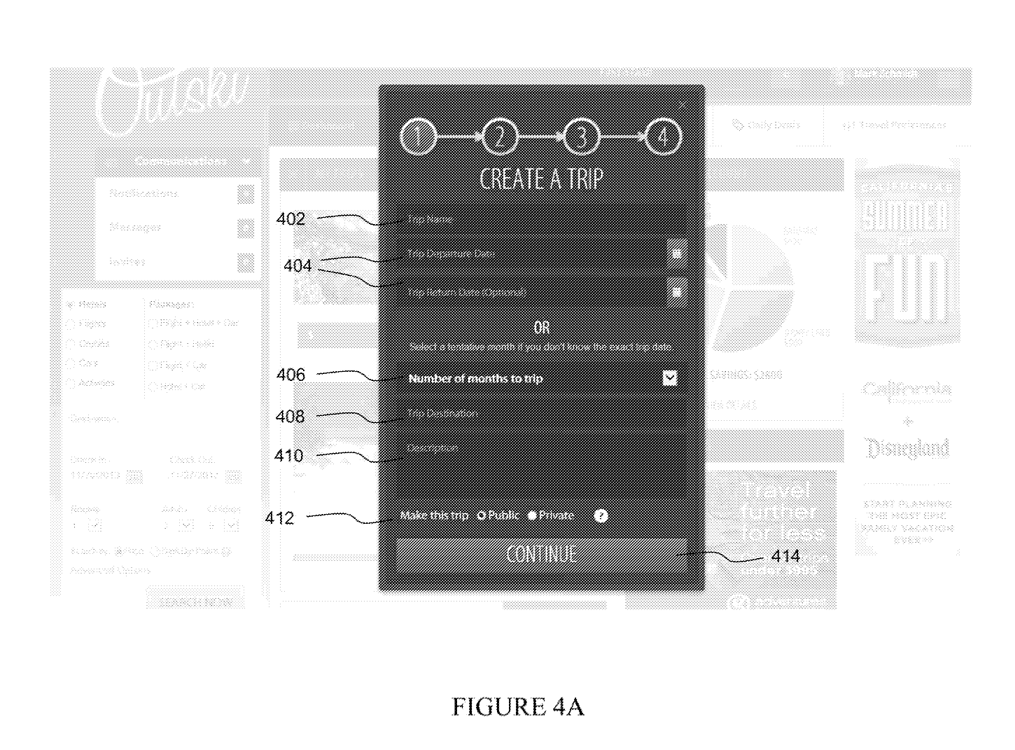

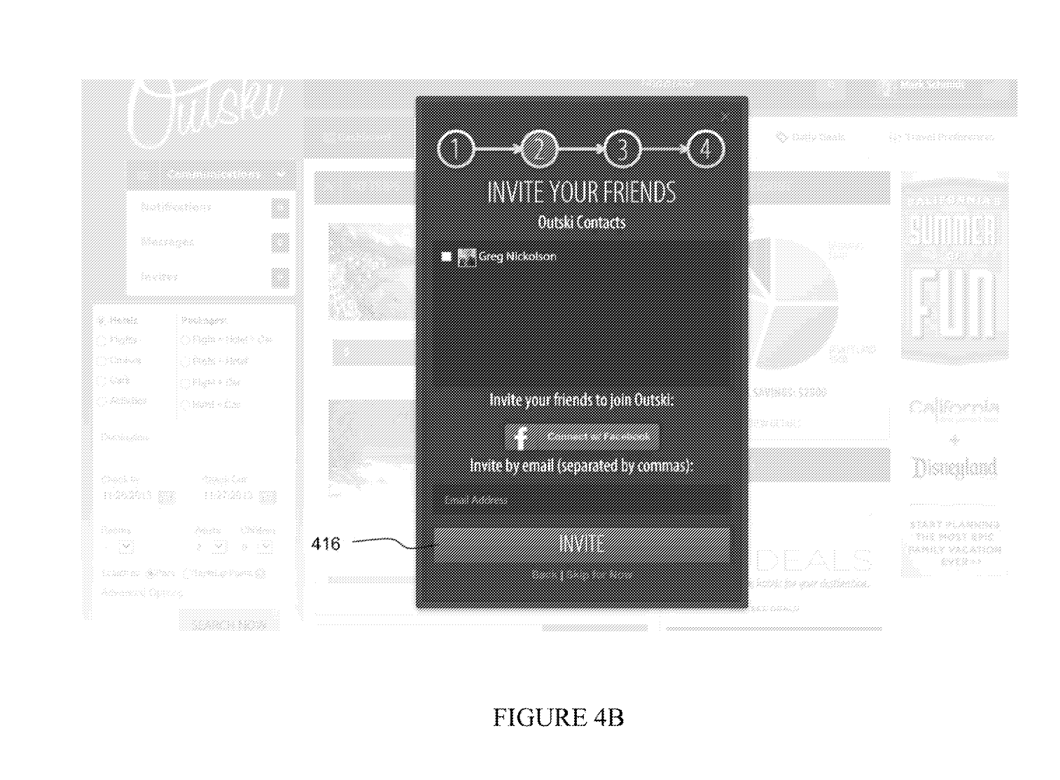

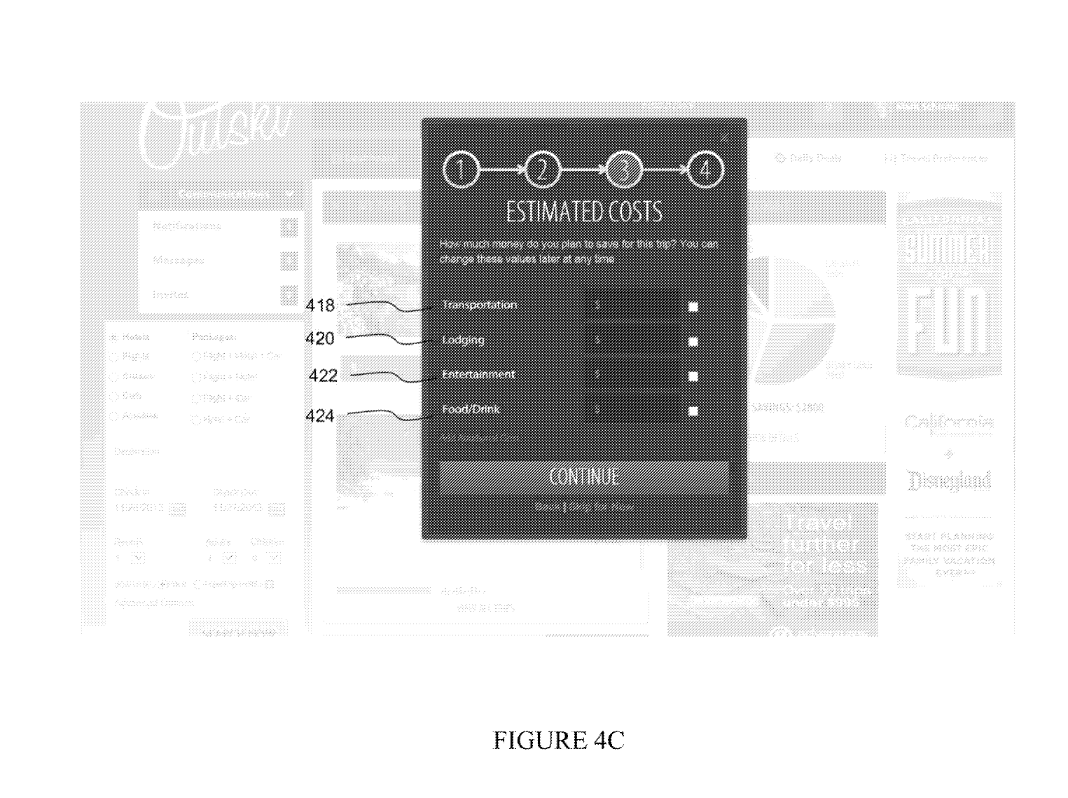

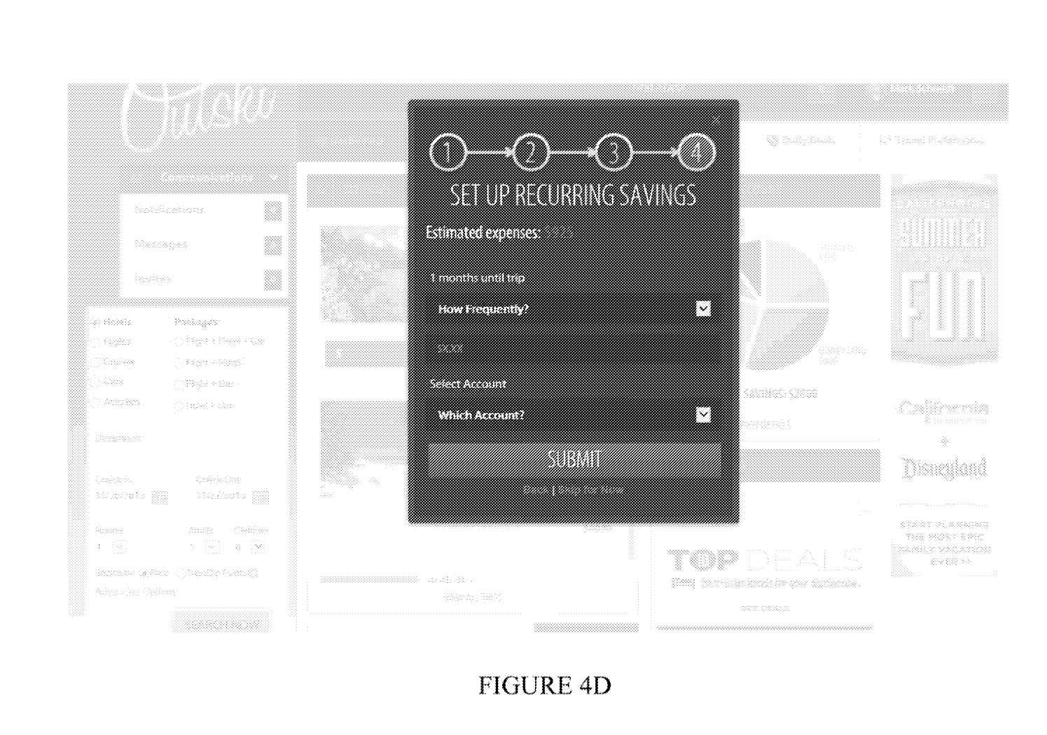

Referring now to FIGS. 4A and 413, the planning coordination system 204 may present the user with a series of interfaces, questions, or drop down boxes associated with common travel components associated with a trip. For example, the planning coordination system 204 may present a first user interface window prompting the user to input information relating to the trip such as: the trip name 402; dates of travel 404 or expected time until trip will be taken 406; travel destination 408; type of trip to be taken 410; and whether the trip is public or private 412. Once complete, the planning coordination system 204 may present a second user interface window prompting the user to selectively invite 416 other users to join the trip. As the user enters information relating to the trip, the information may be captured and saved by the planning coordination system 204. The newly created trip 304 may then be added to the user's Dashboard page 300.

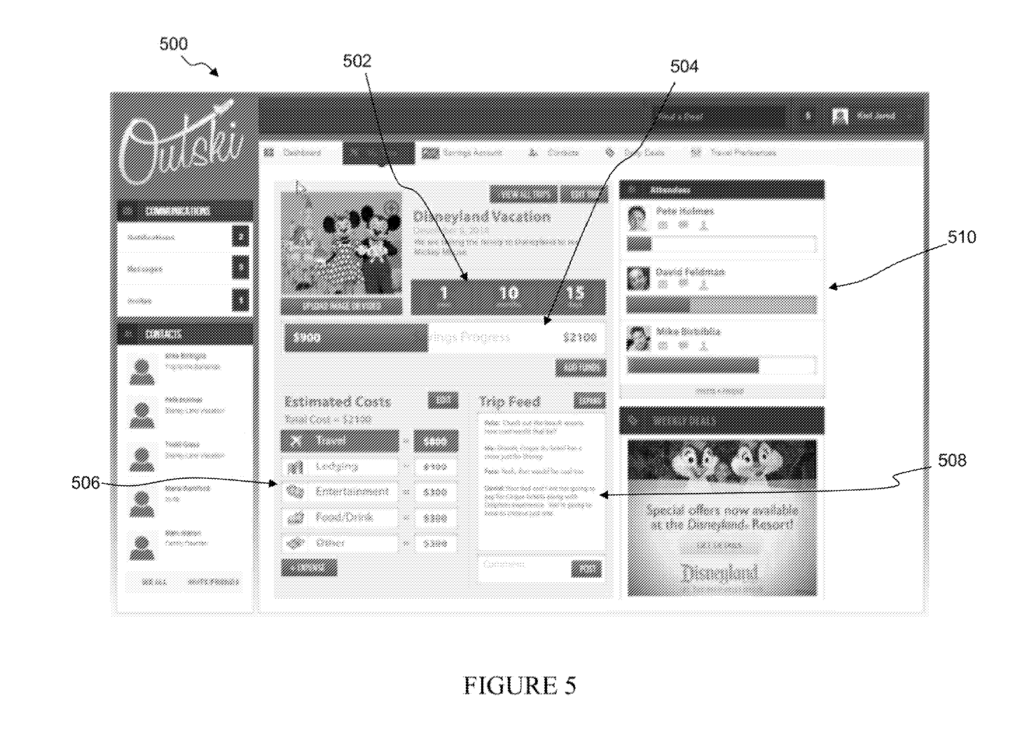

The planning coordination system 204 may also provide travel planning for groups of individual users. For example, the user may be presented with an invite others button 414 that allows the user to invite other users to join the created trip 304 as travel partners or companions. In response to the invitation of other users, the planning coordination system 204 may generate an invite message that may be forwarded to the selected users through any suitable method such as by email, a posting on the additional users' social media network account, or a link posted on the additional users' profile pages 300. As additional users join a given trip, the planning coordination system 204 may provide a system to allow the users to collectively communicate and plan the group trip. For example, referring to FIG. 5, the planning coordination system 204 may comprise a communication forum 508 such as a bulletin board, an instantaneous chat feature, and/or an electronic mail program that allows users to communicate with each other. The planning coordination system 204 may also be adapted to allow the user to check on the progress of other users in saving for the group trip and/or booking selected travel components 510. In this way, the user may be able to plan, organize, and/or collaborate on a trip for multiple travelers.

The planning coordination system 204 may further allow users to mark trips as public or private, which may permit or limit the visibility of trip details to other users. The planning coordination system 204 may also allow the user to publish details of the created trip to the social media network 110.

In response to the creation of a new trip, the planning coordination system 204 may generate an estimated budget for the trip according to the selected travel components. For example, the planning coordination system 204 may access the travel reservation system 106 to obtain price estimates for each of the selected travel components. Alternatively, the planning coordination system 204 may prompt the user to enter values associated with costs for any suitable travel component including transportation, lodging, food, and entertainment that may be included into the estimated budget. Referring now to FIGS. 4A and 4B, during the process of creating a new trip, the planning coordination system 204 may present the user with a cost interface window prompting the user to input expected costs information relating to the trip such as: transportation 418; lodging 420; entertainment 422; and dining 424. The planning coordination system 204 may then present the user with a savings interface to facilitate the creation of a savings plan for the trip according to the estimated budget, time to save for the estimated budget, and any other suitable criteria.

The planning coordination system 204 may also access a set of travel preferences associated with the user's profile to generate a more accurate budget. The travel preferences may comprise any suitable criteria such as: preferred flight class; preferred hotels; preferred car rental categories, common activities enjoyed during a trip, type of dining preferred, and any other suitable criteria that may be used by the planning coordination system 204 to generate an estimated budget.

The user may be able to access each of the items presented on the Dashboard page 300 to obtain more detailed information. For example, referring again to FIGS. 3 and 5, by selecting a link associated with the created trip 304, the user may be presented with a detailed trip page 500 for the created trip 304. The detailed trip page 500 may display trip specific information such as a countdown to the beginning of the trip 502, an amount saved towards the estimated travel budget 504, a status of individual travel elements 506, and an indication of the amounts saved towards the estimated budget for any travel companions 510. For example, the status of individual travel elements 506 may indicate whether or not specific travel components such as flight reservations, lodging, insurance, and the like have been purchased.

The planning coordination system 204 may also allow users to create checklists from templates that may be edited, printed, and/or communicated to other users. For example, in one embodiment, the user may create a checklist including items needed for a given trip such as clothing, equipment, and related accessories and the planning coordination system 204 may facilitate the purchase of the items over an appropriate retailer. The planning coordination system 204 may also provide reminders for items on the checklist ahead of the starting date for the trip.

The detailed trip page 500 may also present the user with options to book one or more travel components. For example, each individual travel element 506 may comprise a link adapted to access the travel reservation system 106, which may direct the user to one or more travel webpages where the user can search for a desired element such as a hotel reservation, flight, rental car, or the like. Alternatively, the travel reservation system 106 may be adapted to process the saved trip information and present the user with automated search results of available travel options to allow the user to compare various options such as price, flight times, and the like without having to visit a third party website. For example, if the user has indicated an airline flight is the desired mode of transportation for a given trip, the travel reservation system 106 may be adapted to process saved information pertaining to the known dates of travel and destination to search one or more sources for available flight options, such as travel webpages, airline webpages, travel metasearch engines, and the like, to present the user with a list of available flights that the user may review, book, save for comparison, or forward to travel companions.

Similarly, the planning coordination system 204 may be adapted to automatically access the travel reservation system 106 and search for advertised specials and present them to the user if a particular special matches criteria relating to the user's saved trips. The planning coordination system 204 may also identify those elements of a trip already booked by the user and exclude those from the automated search function. For example, if the user has indicated on a given trip that they have already purchased airline tickets, the planning coordination system 204 may exclude air travel from being presented to the user and instead only present travel options and/or advertising relating to other remaining unbooked travel components saved for the created trip 304. The planning coordination system 204 may also present the user with trip suggestions that coincide with completed or planned trips by utilizing known information for the traveler pertaining the user's travel preferences, activities typically engaged in during travel, common interests shared with other users/travel companions linked to the first user, and the like. The planning coordination system 204 may also suitably obtain historical weather information relating to each travel location and recommend appropriate clothing and/or accessories to the user.

The travel planning system 102 may also allow users to share information about their trip with other users. In one embodiment, the planning coordination system 204 may further allow the user to share information directly with or among other users and/or provide links to existing social media platforms to facilitate the sharing of information, such as by uploading pictures and/or videos related to saved trips, which may then be accessible by other users. For example, the planning coordination system 204 may comprise a social media module adapted to allow users to communicate with each other, such as by user-to-user messages, discussion boards, and the posting of reviews to various travel components. Referring again to FIG. 5, in one embodiment, the detailed trip page 500 may comprise a message board 508 adapted to allow each user associated with the trip to post messages. The social media module may also allow the user to review other users' profile pages and review trips created or taken by other users. The social media module may also comprise an interactive map feature to allow the user to create a visual depiction of past travels and saved trips.

The funds management system 206 may provide the user with an automated savings feature and a fund allocation system. The funds management system 206 may comprise any suitable system for allowing users to save money that may be used to pay for expenses relating to one or more of the user's saved trips. For example, in response to a command from the user computing device 104, the planning coordination system 204 may activate the funds management system 206 and guide the user through a process for creating a user savings account with the banking system 108. In one embodiment, the funds management system 206 may be communicatively linked the banking system 108 through a secure data link and create a user savings account at the banking system 108 in the user's name. In a second embodiment, the funds management system 206 may redirect the user to a web page for the banking system 108 that allows the user to create the user savings account without having to submit personal information through the funds management system 206.

Alternatively, the funds management system 206 may be linked to multiple banking systems 108 and be adapted to provide the user with a list of available institutions that may be selected to open the user savings account or which may be used to transfer funds to or from. The funds management system 206 may further be adapted to facilitate the transfer of funds between the user savings account and one or more existing accounts owned by the user, such as a personal checking account or a credit card account. The funds management system 206 may also suitably facilitate funds transfers through a third party payment processor, gift cards, or any other suitable monetary source.

The funds management system 206 may further allow the user to allocate funds saved in the user savings account in any desired fashion. In one embodiment, the funds management system 206 may store a deposit into a general pool that the user may selectively allocate among one or more saved trips. For example, if the user has saved more than one trip in the planning coordination system 204, the user may access the funds management system 206 and assign specific values of money towards each of the saved trips.

In one embodiment, the funds management system 206 may also be configured to allow the user to set up individual and/or regularly occurring automatic transfers from the user's existing account to the user savings account. The funds management system 206 may also facilitate the regular deposit of funds into the user savings account from a source such as a direct deposit of funds from the user's paycheck.

As funds are transferred into the user savings account, the planning coordination system 204 may monitor the amount of transferred funds and store the results to assist the user with tracking their progress towards saving for the saved trip. For example, referring again to FIGS. 3 and 5, the planning coordination system 204 may present the user with a real-time summary of the amount saved 306 towards each trip as a cumulative amount saved and/or as a percentage of the anticipated total amount needed.

Users may be able to use funds from the user savings account to directly pay for travel-related costs or transfer an amount back into their existing account to provide funds for travel. For example, if the user selects a desired hotel that requires pre-payment, the user may use a personal credit card to pay for the hotel reservation and then transfer funds from the user savings account to their personal checking account so that they may pay their credit card bill. Alternatively, the planning coordination system 204 may be adapted to access the funds management system 206 and allow the user pay for the hotel reservation directly from their user savings account.

The funds management system 206 may allow the user to allocate funds within the user savings account to a payment method such as: a pre-paid credit card, debit card, checking account, mobile payment application running on a smartphone, and the like. The funds management system 206 may be accessed by any suitable method and may control the allocation of funds by any suitable method. In one embodiment, the funds management system 206 may be accessed from the user's Dashboard page 300 and allow the user to selectively allocate funds between the user savings account and the payment method. In response, the funds management system 206 may establish a link with the banking system 108 and instruct the banking system 108 to initiate a transfer of funds corresponding to the allocation made by the user. For example, the payment method may comprise a reloadable debit card and the funds management system 206 may be configured to allow the user to transfer funds saved in the user savings account to the reloadable debit card such that the user is able to use the card to pay for purchased travel components, while traveling to pay for travel related expenses, and/or obtain cash at an automated teller machine.

In addition, the reloadable debit card may be tied to a mobile payment system installed on the user computing device 104 that allows the user computing device 104 to be used in place of the debit card itself. For example, the mobile payment system may comprise any suitable system sometimes referred to as mobile money, mobile money transfer, and/or mobile wallet, which generally refers to payment services operated under financial regulation and performed from or via a mobile device. Instead of paying with cash, check, or credit cards, the user may use a mobile phone to pay for travel, travel-related services, merchandise, and other goods and services. The mobile payment systems may include systems such as: QR™ code based payment systems; contactless near field communication; cloud-based mobile payments; audio signal-based payments; direct carrier/bank co-operation systems: and the like.

Funds may be transferred to or from the reloadable payment method in substantially real-time such that the user may monitor, control, or otherwise limit the amount available for use by the reloadable payment method at any given time. For example, in one embodiment, the user may transfer a desired amount of money from the user savings account to the reloadable debit card prior to beginning travel or upon arrival at the travel destination. Subsequently, if the reloadable debit card is misplaced, lost, and/or stolen, the user may access the funds management system 206 and transfer the funds from the reloadable debit card back to the user savings account in substantially real-time to reduce a probability of losing the funds.

The funds management system 206 may also allow the user to set spending limits on the reloadable debit card prior to the date of travel and/or in substantially real-time. For example, the user may set a daily spending limit that is available for use by the reloadable debit card but have the option of adjusting this limit at any time.

The funds management system 206 may also allow the user to transfer funds from the user savings account to an account of another user. In this way, the user may help travel companions save or pay for travel components. The funds management system 206 may also allow the user to request funds from one or more other users.

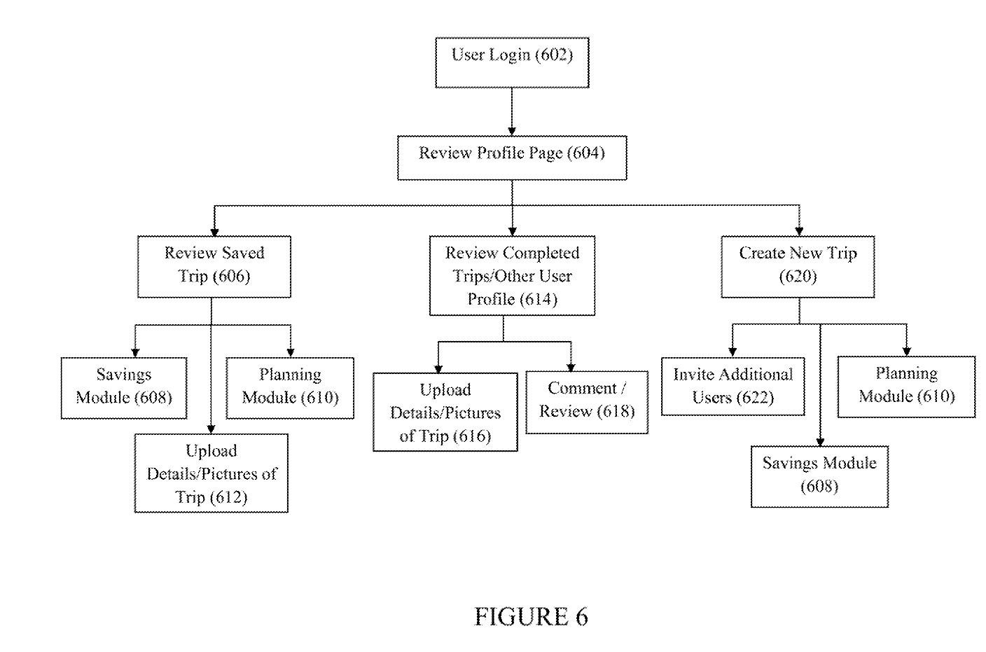

Referring now to FIG. 6, in operation, the user may create or login to their profile (602) and be presented with their Dashboard page 300 (604). The user may then access any desired information such as details of a saved trip (606), a completed trips/other users' profiles (612), or create a new trip (618). If the user selects to view a saved trip, the planning coordination system 204 may present the user with additional options, such as providing access to create or edit savings options associated with the user savings account (608), upload social media content relating to the trip (612), and/or edit travel plans (610). Similarly, if the user opts to create a new trip (620), the planning coordination system 204 may present the user with options to plan the trip (610), create a savings plan for the trip (608), and/or invite additional users to join the trip (622).

The user may also have the option of adding information to completed and/or planned trips that may be shared with additional users via the social media module or through existing social media networks. For example, the user may upload pictures (616) from a completed trip to a standalone social media network and then allow other users to view the images. Alternatively, the planning coordination system 204 may store uploaded images on the server 202 and allow other users to view the images if the user has marked the images as public or otherwise accessible to other users. The planning coordination system 204 may also allow the user provide and/or receive reviews of travel components that may be viewed and/or commented on by others.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or steps between the various elements. Many alternative or additional functional relationships or physical connections may be present in a practical system.

In the foregoing specification, the invention has been described with reference to specific exemplary embodiments. Various modifications and changes may be made, however, without departing from the scope of the present invention as set forth in the claims. The specification and figures are illustrative, rather than restrictive, and modifications are intended to be included within the scope of the present invention. Accordingly, the scope of the invention should be determined by the claims and their legal equivalents rather than by merely the examples described.

For example, the steps recited in any method or process claims may be executed in any order and are not limited to the specific order presented in the claims. Additionally, the components and/or elements recited in any apparatus claims may be assembled or otherwise operationally configured in a variety of permutations and are accordingly not limited to the specific configuration recited in the claims.

Benefits, other advantages and solutions to problems have been described above with regard to particular embodiments; however, any benefit, advantage, solution to problem or any element that may cause any particular benefit, advantage or solution to occur or to become more pronounced are not to be construed as critical, required or essential features or components of any or all the claims.

As used herein, the terms “comprise,” “comprises,” “comprising,” “having,” “including,” “includes” or any variation thereof, are intended to reference a non-exclusive inclusion, such that a process, method, article, composition or apparatus that comprises a list of elements does not include only those elements recited, but may also include other elements not expressly listed or inherent to such process, method, article, composition or apparatus. Other combinations and/or modifications of the above-described structures, arrangements, applications, proportions, elements, materials or components used in the practice of the present technology, in addition to those not specifically recited, may be varied or otherwise particularly adapted to specific environments, manufacturing specifications, design parameters or other operating requirements without departing from the general principles of the same.

1. A travel planning system for organizing travel accessible over a network by a user having a network enabled computing device, comprising:
a server accessible by the computing device over the network;
a planning coordination system communicatively linked to the server and configured to:
communicate with the computing device via the server;
create and save a unique user profile for the user;
create a trip plan according to received trip data having a travel component, wherein the trip data is received from the computing device; and
associate the created trip plan with the unique user profile; and
a funds management system communicatively linked to the planning coordination system, wherein the funds management system is configured to coordinate a user managed savings plan based upon the created trip plan.

2. A travel planning system according to claim 1, wherein the planning coordination system is further configured to:
generate an estimated budget for the trip plan according to the trip data; and
display on the computing device a comparison of the estimated budget and the user managed savings plan.

3. A travel planning system according to claim 2, wherein the planning coordination system is further configured to generate the estimated budget for the trip plan according to a user preference corresponding to the travel component.

4. A travel planning system according to claim 1, wherein the planning coordination system is further configured to generate a user interface for display on the computing device.

5. A travel planning system according to claim 4, further comprising a travel reservation system, wherein:
the planning coordination system is configured to activate a link on the user interface associated with the travel component; and
the link accesses the travel reservation system to allow the user to search for and purchase the travel component.

6. A travel planning system according to claim 5, wherein the planning coordination system is further configured to:
track when the travel component is purchased; and
deactivate the link associated with the purchased travel component.

7. A travel planning system according to claim 6, wherein the funds management system is further configured to:
communicate with a banking system;
facilitate the creation of a user savings account with the banking system;
facilitate a deposit of funds into the user savings account;
monitor the user savings account to track funds saved in the user savings account;
selectively allocate a portion of the saved funds to the created trip plan according to a user preference; and
present on the user interface an overview of how the saved funds are allocated.

8. A travel planning system according to claim 5, wherein the funds management system is further configured to access the user savings account and coordinate a transfer of funds between the banking system and the travel reservation system to pay for the purchased travel component.

9. A travel planning system according to claim 5, wherein the funds management system is further configured to access the user savings account and coordinate a transfer of funds between the user savings account and a payment method of the user.

10. A travel planning system according to claim 4, wherein the user interface comprises a detailed trip web page including status information pertaining to the trip plan.

11. A travel planning system according to claim 1, wherein the planning coordination system is further configured to allow the user to associate the created trip plan with an additional user to facilitate collaborative planning between the user and the additional user.

12. A travel planning system according to claim 1, wherein the planning coordination system is further configured to communicate information relating to the created trip plan to a social media network.

13. A method of organizing travel by a user having a network enabled computing device communicating configured to communicate with a server over a network, comprising:
communicating a user interface for a planning coordination system to the computing device by the server;
receiving trip data having a travel component, wherein the trip data is communicated to the planning coordination system from the computing device over the server;
creating a trip plan with the planning coordination system according to the received trip data;
saving the trip plan to a user profile associated with the user; and
coordinating a user managed savings plan based upon the created trip plan with a funds management system linked to the planning coordination system.

14. A method of according to claim 13, further comprising:
generating an estimated budget for the trip plan according to the travel component; and
displaying on the computing device a comparison of the estimated budget and the user managed savings plan.

15. A method of according to claim 14, further comprising:
activating a link on the user interface associated with the travel component; and
accessing a travel reservation system in response to the user selecting the link, wherein the travel reservation system is configured to allow the user to search for and purchase the travel component.

16. A method of according to claim 15, further comprising:
tracking when a travel component is purchased; and
deactivating the link associated in response to the user purchasing the travel component.

17. A method of organizing travel according to claim 15, further comprising:
causing the funds management system to communicate with a banking system to facilitate creation of a user savings account in response to a user request;
facilitating a deposit of funds into the user savings account;
monitoring the user savings account with the funds management system to track an amount of saved funds;
allocating a portion of the amount of saved fimds to the saved trip plan according to a user preference; and
presenting on the user interface an overview of how the saved funds are allocated.

18. A method of organizing travel according to claim 17, further comprising:
accessing the user savings account in response to a purchase of a travel component by the user on the travel reservation system; and
coordinating a transfer of funds from the banking system to the travel reservation system corresponding to the purchased travel component.

19. A method of organizing travel according to claim 17, further comprising:
accessing the user savings account in response to a command from the user; and
coordinating a transfer of funds between the user savings account and a payment method issued to the user by the banking system.

20. A method of organizing travel according to claim 13, thrther comprising displaying on the user interface a detailed trip web page including status information for the trip plan.

21. A method of organizing travel according to claim 13, further comprising associating trip plans for multiple users by the planning coordination system to facilitate collaborative planning between the multiple users.

22. A method of organizing travel according to claim 13, further comprising communicating information relating to the trip plan to a social media network.

23. A non-transitory computer-readable medium storing computer-executable instructions for organizing travel by a user having a network enabled computing device communicating configured to communicate with a server over a network, wherein the instructions are configured to cause the server to execute steps comprising:
displaying a user interface for a planning coordination system on the computing device;
receiving trip data having a travel component, wherein the trip data is communicated to the planning coordination system from the computing device;
creating a trip plan with the planning coordination system according to the received trip data;
saving the trip plan to a user profile associated with the user; and
coordinating a user managed savings plan based upon the created trip plan with a funds management system linked to the planning coordination system.

24. A method of according to claim 23, further comprising:
generating an estimated budget for the trip plan according to the travel component; and
causing the user interface to display a comparison of the estimated budget and the user managed savings plan.

25. A method of according to claim 23, further comprising:
activating a link on the user interface associated with the travel component; and
accessing a travel reservation system in response to the user selecting the link, wherein the travel reservation system is configured to allow the user to search for and purchase the travel component.

26. A method of according to claim 25, further comprising:
tracking when a travel component is purchased; and
deactivating the link associated in response to the user purchasing the travel component.

27. A method of organizing travel according to claim 25, further comprising:
causing the funds management system to communicate with a banking system to facilitate creation of a user savings account in response to a user request;
monitoring the user savings account with the funds management system to track an amount of saved funds:
allocating the amount of saved funds to the created trip plan according to a user preference; and
presenting on the user interface an overview of how the saved funds are allocated.

28. A method of organizing travel according to claim 27, further comprising:
accessing the user savings account in response to a purchase of a travel component by the user on the travel reservation system; and
coordinating a transfer of funds from the banking system to the travel reservation system corresponding to the purchased travel component.

29. A method of organizing travel according to claim 27, further comprising:
accessing the user savings account in response to a command from the user; and
coordinating a transfer of funds between the user savings account and a payment method issued to the user by the banking system.

30. A method of organizing travel according to claim 23, further comprising displaying on the user interface a detailed trip web page including status information fotr the trip plan.

31. A method of organizing travel according to claim 23, further comprising associating trip plans for multiple users by the planning coordination system to facilitate collaborative planning between the multiple users.

32. A method of organizing travel according to claim 23, further comprising communicating information relating to the trip plan to a social media network.
